(19) United States
(12) Patent Application Publication
(10) Pub. No.: US 2007/0203975 A1
(43) Pub. Date: Aug. 30, 2007

(54) HTML CODE FOR PROVIDING A STORE LOCATOR FEATURE

(76) Inventor: Michael Grover, Rochester, NY (US)

Correspondence Address: Frank V. Gallucci, Esq.;Fujifilm America, Inc., 155 Bellwood Drive, Rochester, NY, 14606, US

(21) Appl. No.: 11/462,533

(22) Filed: Aug. 4, 2006

Related U.S. Application Data
(60) Provisional application No. 60/774,182, filed on Feb. 16, 2006.

(51) Int. Cl. G06F 15/16

(52) U.S. Cl. 709/203

(57) ABSTRACT

A method for a web-based photo service company to conveniently provide locations where a customer can pick up printed photographs by providing HTML code to a company with more than one photo printing location for insertion into the company's home web page. The code generates an address selector box where a customer wanting to have prints picked up in a particular geographical area can enter the address of the geographical area and receive a list of the photo printing locations in or near the geographical area.

### CROSS REFERENCE TO RELATED APPLICATIONS

This application claims the benefit of U.S. Provisional Application No. 60/774,182 filed on Feb. 16, 2006.

### TECHNICAL FIELD

The present invention relates to HTML code that can be added to an existing web page and, more particularly, to HTML code which provides a store locator feature to an existing web page.

### BACKGROUND OF THE INVENTION

Web-based photo service companies which process customer's photographs from digital picture data transferred from the user to the photo service company over the web have contracts with stores which have print processing capabilities so that a customer of the photo service company will have a convenient place to pick up printed photographs. A constant goal of the web-based service companies is to provide services convenient to their customers.

What is needed is a method to enhance a customer's convenience when using the web-based photo service provider.

Furthermore, what is needed is a method that allows web-based service providers to easily add a function that allows users to locate stores that provide various printing services.

Furthermore still, what is needed is a method of adding a store location feature that is easily added to an existing web page and does not require a costly redesign of the web site.

### SUMMARY OF THE INVENTION

The present invention provides a method that allows web-based service providers, such as on-line photo fulfillment stores, to easily add a function that allows users to locate stores that provide various printing services. Furthermore, the present invention provides a method of adding a store location feature that is easily added to an existing web page and does not require a costly redesign of the web site.

Briefly described in one embodiment of the present invention, a method for enabling a customer to find a location where prints of photographs can be obtained is by generating HTML code which can be inserted into an existing web page and which will allow a viewer of the web page to enter information about a geographical area where one or more of the locations are present, the HTML code passing the information to a service center URL used by a web-based photo processing service company after the data is entered, and the service center providing a list of the one or more of the locations in response to receiving the information.

### BRIEF DESCRIPTION OF THE DRAWINGS

The accompanying drawings, which are incorporated into and form a part of the specification, illustrate the preferred embodiment of the present invention and, together with the description, serve to explain the principles of the invention. The drawings are only for the purpose of illustrating a preferred embodiment of the invention and are not to be construed as limiting the invention.

FIG. 1 shows a customer address entry box on a chain store's web page for use by a customer in locating one or more of the chain stores which has photo printing capabilities;

FIG. 2 shows a web page with an example of the search results after a customer uses the customer entry box shown in FIG. 1; and

FIG. 3 is a flow diagram showing an embodiment of the data flow for a photo store locator system according to the present invention.

### DESCRIPTION OF THE PREFERRED EMBODIMENTS

A web-based photo service company has a presence on the world wide web to receive customer's photographs transferred as images over the internet to the web-based photo service company. The web-based photo service company processes the photograph data and stores the processed photos in their data base. A customer can view the photographs, have them sent by e-mail to third parties, and have printed photographs made by directing the web-based photo service company to send the image data to a photo printing facility which has a contract with the web-based photo service company and which is a convenient pick up location for the customer. The convenient location may be where the customer can pick up the prints or a location for someone other than the customer to pick up the customer's prints.

The web-based photo service company may have contracts with chain stores such as drug store chains, discount store chains, and the like. The term “chain stores,” as used herein, also includes two or more independently owned stores which have agreed to support the photo services of the other stores. However, often not all locations of these chain stores will have photo printing capabilities, and the chain store home web page generally does not indicate which of their stores has these printing capabilities. Thus, a customer may have to call an individual store to ask if the store can make photo prints.

The lack of photo printing information on a chain store's web page can result in unnecessary phone calls and wasted trips for customers of the web-based photo service company, thus making the web-based photo service company's services less convenient to the customer.

A solution is to offer a chain store company that has a contract with the web-based photo service company a block of code which may be provided by the web-based photo service company that the chain store company could insert into the HTML code of its home web page.

One such block of HTML code is the following JavaScript IFrame code:

```
----BEGIN CODE---
<script type=“text/javascript” language=“javascript”>
<!--
  var LoadStateID =“”;
  var ClientID = “qGvvtcmDjGE=”;
  var ClientDCDDomain = ‘AD3. developing.com’;
  var ApplicationKey = ‘AF63-ACF7-4A60-2D56’;
  var SearchOption = “Both”;
  var ControlOutputType = “IFrame”;
//-->
</script>
<script type=“text/javascript”
src=“http://AD3.developing.com/includes/js/storesearch.js”>
</script>
----END CODE----
```

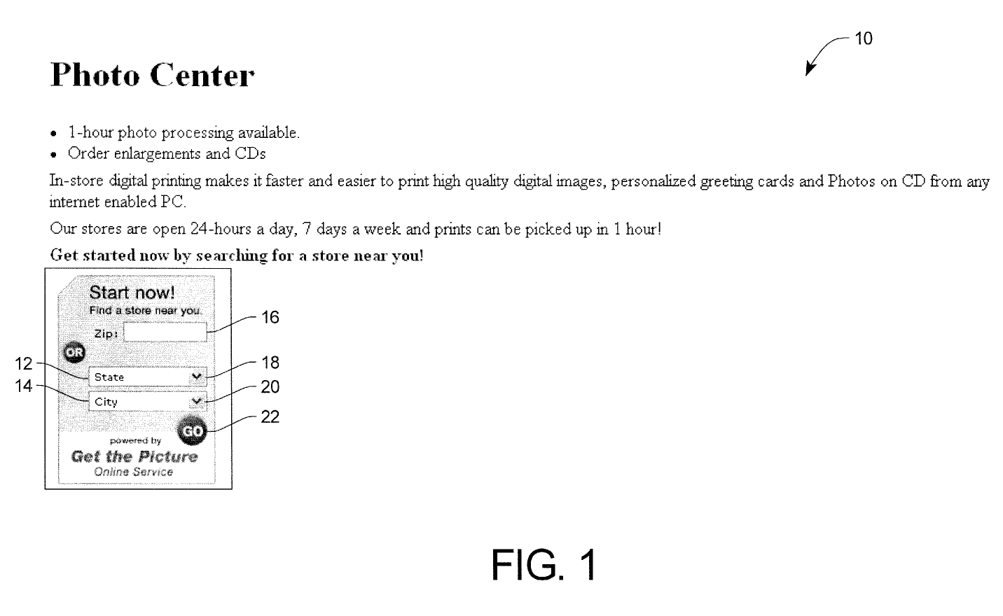

The “ClientID” is the identification code assigned to the particular store chain by the web-based photo service company; the “ClientDCDDomain” is the URL for the web-based photo service company to process requests from the store search box; the “ApplicationKey” is the version of the web-based photo service company's application; the “SearchOption” selects the search boxes which will appear in the store search box, in this case “both” means both the post office address box and the zip code box as shown in FIG. 1; and the “ControlOutputType” specifies that an HTML IFrame is to be used to load the store search box content. The “ClientID,” “ClientDCDDomain,” “ApplicationKey,” “SearchOption,” and “ControlOutputType” variables are set by the web-based photo service company.

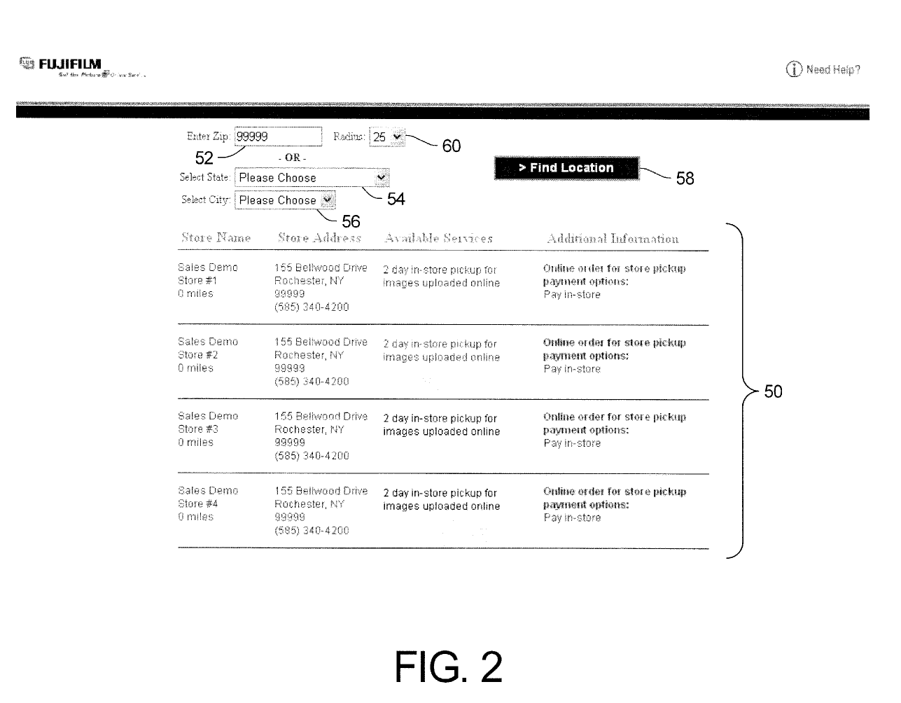

When this HTML code is added to the chain store web page, the store search box frame 10 shown in FIG. 1 will show up on the web page to enable a customer of the web-based photo service company to locate the stores which have photo printing capabilities near the address entered in the store search box. With this information the customer will know that the photographic prints they want can be made available to them at one of the stores listed in the response to a store search request shown in FIG. 2.

As shown in FIG. 1, the address search box 10 includes drop down boxes 12 and 14 for entering a location by state and city, respectively, or by entering a zip code in box 16. After the data is entered into the drop down boxes 12 and 14 or into box 16 and the “GO” button 22 is clicked, the customer's web browser is redirected to the web-based service company website to display the store search results on the web page shown in FIG. 2.

In FIG. 2 a list 50 of chain stores which have photo printing facilities within 25 miles of the center of the zip code area or the city selected is displayed, and the customer can select the desired pick-up location, or can modify the location or the size of the search area, in the same manner that the web-based photo service company's own web pages would process information from a customer. Above the list 50 are selection boxes 52, 54, and 56 which operate in the same manner as the boxes 12, 24, and 16, respectively, in FIG. 1. A “Find Location” button 58 corresponds to the “GO” button 22 in FIG. 1. An additional box 60 allows the customer to change the default 25 mile radius of the search area.

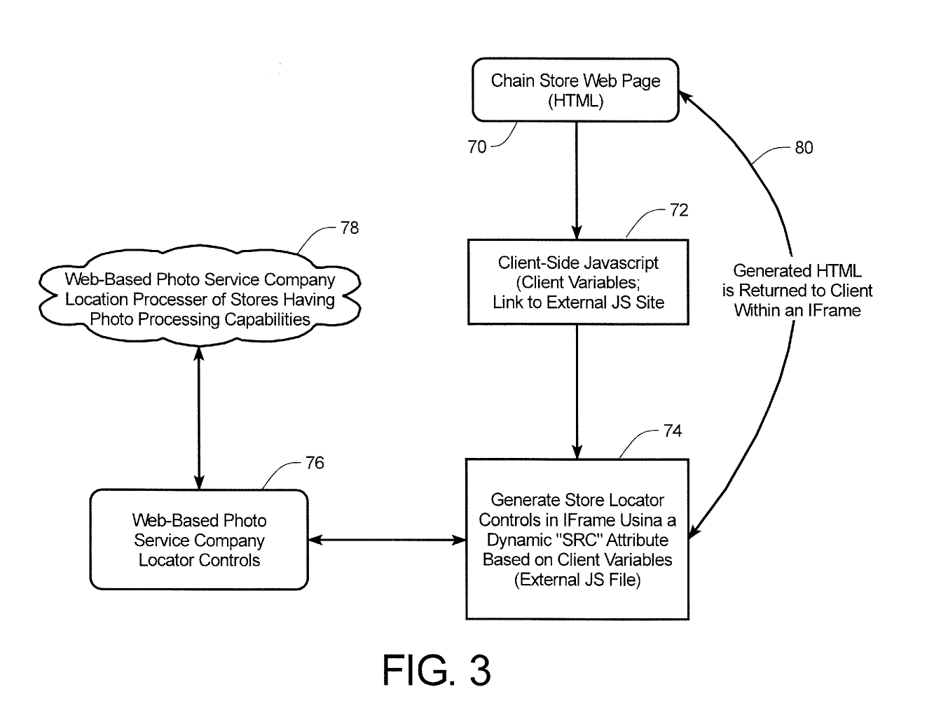

FIG. 3 is a flow diagram showing the data flow for the photo store locator system. Block 70 represents the chain store web page, block 72 represents the JavaScript code shown above, and block 74 represents the external JavaScript (JS) file shown in the “SRC” line of the JavaScript code. The external JS file is located in a server owned or controlled by the web-based photo service company. The web-based photo service company server is interconnected to box 76 which represents the locator controls program which may reside on a separate server or on the same web-based photo service company server. The locator controls program is interconnected to box 78 which represents the location processor that generates the list 50 of stores which meet the criteria set by the location controls program. The location processor of box 78 may reside on a separate server or on the same web-based photo service company server.

In operation, when the chain store web page is loaded into the web browser of a customer, the browser requests the external JS file (Box 74) that renders the IFrame in the browser via line 80. The IFrame gets its content from Box 76 which is directly linked to Box 78 which, in the preferred embodiment, only processes requests that originated from Box 70. Box 78 instantiates a list of states that appear when a customer uses the state selection drop down box 12 in FIG. 1. Once a state is selected, the list of cities that appear when the customer uses the city selection drop down box 14 in FIG. 1 gets updated with cities found in that state. The generation of both the state and city list is by the location processor in box 78. When the customer clicks the “GO” button 22, the location processor in box 78 creates the list 50 of chain stores which have photo printing facilities as shown in FIG. 2.

The embodiments described are to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

What is claimed is:

1. A method for enabling a customer to find a location where prints of photographs can be obtained comprising the steps of:
a) generating HTML code which can be inserted into an existing web page which will allow a viewer of the web page to enter information about a geographical area where one or more of said locations are present;
b) said HTML code passing said information to a service center URL used by a web-based photo processing service provider after said data is entered; and
c) said service center providing a list of said one or more of said locations in response to receiving said information.

2. The method of claim 1 wherein said step of providing said list is generated by a list provided by said web-based photo processing service provider.

3. The method of claim 1 wherein said code is passed to a service company URL operated by said web-based photo processing service provider.

4. The method of claim 1 wherein said step of generating said HTML code further comprises the steps of identifying a requester of such code and setting one or more code options in said HTML code appropriate for said requester.

5. The method of claim 1 wherein said HTML code contains JavaScript.

6. The method of claim 1 wherein said URL is accessed when a user opens said web page in the user's web browser.

7. The method of claim 1 further comprising the step of receiving a selection by said customer of one of said list of one or more of said locations.

8. The method of claim 1 further comprising the step of passing said address information to a locator controller program which in turn passes said address information to a location processor which generates said list.

9. The method of claim 8 further comprising the step of passing said list from said location processor to said URL.

10. The method of claim 8 further comprising the step of passing said list from said URL to said user's web browser.

11. A method for enabling a user to find a location where prints of photographs can be obtained comprising the steps of:
a) generating JavaScript IFrame code for inclusion in a web page, said code incorporating an external URL located on a server controlled by a web-based photo service provider;
b) said JavaScript IFrame code creating a data input area on a user's web browser when said web page is brought up by said user, said data input area being adapted to receive address information;
c) passing said address information to a location processor upon receiving a predetermined input from said user in said data input area;
d) generating a list of locations by said location processor that can provide prints of photographs in response to said address information;
e) passing said list of locations to said external URL;
f) creating a photographic print locations web page containing said list of locations from said external URL; and
g) replacing said web page on said user's web browser with said photographic print locations web page by said URL.

12. The method of claim 11 wherein said step of generating said HTML code further comprises the steps of identifying a requester of such code and setting one or more code options in said JavaScript IFrame code appropriate for said requester.

13. The method of claim 11 further comprising the step of receiving a selection by said customer of one of said list of locations.

14. The method of claim 11 wherein step c) further comprises the step of passing said address information to a locator controller program which in turn passes said address information to said location processor.

15. The method of claim 14 wherein step e) further comprises the step of passing said list of locations from said location processor to said locator controller program which in turn passes said list of locations to said external URL.

16. A method of adding a store location feature to an existing chain store's web page comprising the steps of:
a) adding HTML code to said web page to generate JavaScript IFrame code for inclusion in said web page, said code incorporating an external URL located on a server controlled by a web-based photo service provider;
b) said JavaScript IFrame code creating a data input area on a user's web browser when said web page is brought up by said user, said data input area being adapted to receive address information;
c) passing said address information to a location processor upon receiving a predetermined input from said user in said data input area;
d) generating a list of locations by said location processor that can provide prints of photographs in response to said address information;
e) passing said list of locations to said external URL;
f) creating a photographic print locations web page containing said list of locations from said external URL; and
g) replacing said web page on said user's web browser with said photographic print locations web page by said URL.
